(19) United States
(12) Patent Application Publication
(10) Pub. No.: US 2006/0078285 A1
(43) Pub. Date: Apr. 13, 2006

(54) Recording/reproduction apparatus, recording/reproducing method, program, and medium for the same

(75) Inventor: Yoshiaki Arishima, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/239,743

(22) Filed: Sep. 30, 2005

(30) Foreign Application Priority Data
Oct. 5, 2004 (JP) P2004-292874

(51) Int. Cl. H04N 5/76; H04N 5/781

(52) U.S. Cl. 386/46; 386/125

(57) ABSTRACT

When contents recorded program by program can be reproduced, the contents can be reproduced without any pause, even if the recording unit and recorded contents do not coincide with each other. Guidance information for contents broadcasted through a broadcast service is acquired, and based on the acquired guidance information, a reservation for picture recording is made for contents with the possibility of extension of broadcast time thereof by extending the recording time within a time zone not conflicting with a reservation for recording another contents, and when the contents recorded on the reservation is reproduced, after reproduction of the contents with the possibility of extension of the broadcast time thereof is finished, a record of another contents produced from the same broadcast service and recorded substantially in succession to the reproduced contents is searched out, and the contents searched out is reproduced.

### CROSS-REFERENCE TO RELATED APPLICATIONS

The present invention claims priority from Japanese Patent Application No. JP 2004-292874 filed on Oct. 5, 2004, the disclosure of which is hereby incorporated by reference herein.

### BACKGROUND OF THE INVENTION

The present invention relates to a recording/reproduction apparatus and a recording/reproducing method for recording, for example, broadcasted contents in a recording medium such as a hard disk and reproducing the recorded contents, as well as to a program for providing controls for recording broadcasted contents and reproducing the recorded contents and a recording medium with the program stored therein.

As an apparatus for recording contents (pictures) of television broadcasting, a hard disk-based recording/reproduction apparatus using a hard disk as a recording medium has been put into practical use. This hard disk-based recording/reproduction apparatus has a recording capacity of, for example, several tens of G bytes, and can record therein television broadcast signals continuously provided for several tens of hours. The recording capacity in terms of the recordable period of time may further be enhanced in association with improvement of the recording density of a recording medium such as a hard disk or improvement of the technique for compressing broadcasted data.

Some hard disk-based recorders/reproducers can receive electronic program guidance data referred to as EPG (Electronic Program Guide) for facilitating picture recording of television programs. In broadcasting systems such as digital satellite broadcasting, the EPG data is added to broadcasted data, and in a case of broadcasting based on surface waves which is an analog broadcast service, the EPG data is added to the broadcasted data for transmission only within a specified time zone such as a blanking period of an image signal on a prespecified channel. Further in some other cases, the EPG data is completely separated from broadcasted data and is distributed to a user's recording/reproduction apparatus via a transfer path such as the Internet.

By receiving the EPG data transmitted as described above, having a program table for television broadcast services displayed on a screen of a receiver, and selecting a program to be recorded from the program table, a user can relatively easily make a reservation for picture recording of desired programs. When broadcasted programs are recorded by means of reservation using the EPG data, the recorded contents is managed program by program even when the recorded program are reproduced. For example, it is possible to have a title list for recorded programs displayed and select programs to be reproduced from the title list.

In some of the programs provided through a television broadcasting service, the broadcast time may be extended depending on a content of the programs. For example, when a sports game such as baseball or football is relayed, the broadcast time is often extended because length of the game extends. In a case where the broadcast time for sports game relay broadcasting may be extended, generally the possibility is indicated in the EPG data. Therefore, when picture recording of only a sports relay broadcast program is reserved, by setting the broadcast time so that the program is recorded until the end of the expected longest broadcast time, the program can be surely recorded as long as possible.

An example of countermeasures against extension of broadcast time when, for example, a sports game relay broadcasting program is reserved for picture recording is disclosed in Japanese Patent Laid-open No. 2003-134431 (hereinafter referred to as Patent Document 1).

However, in a case where, after the end of broadcast time for a sports game program having the possibility of extension, another program is reserved for picture recording, generally the reservation of picture recording of the latter program is treated preferentially, and in that case, picture recording of the sport game program with the broadcast time extended is terminated before the end of the program.

When broadcast time of a sports game program is extended, also start time and end time of a program to be broadcasted in succession to the sports game program having the possibility of extension are delayed by extended broadcast time, and modification of the reserved time for picture recording is required, but often extension of the time for picture recording can not be extended in relation to a reservation of picture recording for other program(s). As described above, when there is a program, broadcast time of which may be extended such as a sports game program, sometimes the program or a program to be broadcasted in succession to the sports game program may not completely be recorded.

On the other hand, in a case of a program reserved for picture recording based on the EPG data or the like, reproduction is managed program by program, so that, even if it is tried to reproduce a recorded program, sometimes the broadcast time for the program may not coincide with the reserved time for picture recording due to the reasons as described above. Therefore, even if a user can select a program to be reproduced, for example, from a title list and reproduce the recorded program, the program may not be reproduced before the end of the program.

More specifically, now it is assumed that, because broadcast time of a sports game program broadcasted just before is extended by 30 minutes, the start time for each of the subsequent broadcast programs on the day is delayed by 30 minutes respectively. In this situation, if a plurality of successive programs are reserved for picture recording, start time of each of the programs to be recorded other than the last program to be recorded can not be delayed, so that a portion corresponding to the last 30 minutes of each of the program is not recorded, and therefore even if reproduction of any of the program is specified, reproduction thereof is stopped 30 minutes before the end of the program.

When a plurality of successive programs are reserved for picture recording, there is the high possibility that a remaining portion of a program is recorded in a recording medium such as a hard disk. However, because the broadcast time and the recording time do not coincide with each other, sometimes it is difficult for a user to specify which program title for reproducing the remaining portion of the program. Especially when a recorder is capable of analyzing a user's preference in relation to TV programs and automatically reproducing a recorded program satisfying the user's preference, the user can not determine whether the remaining portion of the program has been recorded or not, and the user often gives up reproduction of the remaining portion of the program.

### SUMMARY OF THE INVENTION

It is desirable to enable reproduction of contents recorded program by program without pause even when the broadcast time is extended and the recording unit does not coincide with recorded contents.

With the present invention, when received contents is recorded and reproduced, it is possible to acquire guidance information for the contents and also to make a reservation for picture recording of contents with the possibility of extension of the broadcast time thereof, based on the acquired guidance information, by extending the broadcast time within a time range not conflicting with the broadcast time of other contents reserved for recording, and also it is possible, when the reserved and recorded contents is to be reproduced, to search out, after reproduction of contents with the possibility of extension of the broadcast time thereof is finished, records of other contents provided through the same broadcasting service and recorded substantially in succession to the reproduced contents and to reproduce the other contents searched out as described above.

With the functional configuration as described above, even when it is set to record contents program by program and the actual broadcast time of any program is extended, so long as contents broadcasted in succession is recorded, the contents broadcasted in succession is also continuously reproduced, so that contents with the broadcast time shifted from the original time schedule can be reproduced up to the end of the contents.

According to the present invention, even when it is set to record contents program by program and the actual broadcast time of any program is extended, so long as contents broadcasted in succession is recorded, also the contents broadcasted in succession is continuously reproduced, so that a user is liberated from the troublesome operations for searching a section where the contents successively recorded is stored. Especially, when a recorder has the automatic recording capability and a user can not easily determine whether the remaining portion of a program has been actually recorded, this functional configuration is very effective.

In this case, when the other contents recorded substantially in succession is to be reproduced, after reproduction of contents with the possibility of extension of the broadcast time thereof is finished, an inquiry as to whether reproduction is to be continued is displayed, and when continuation of the reproduction is specified in response to the display, the other contents searched out as described above is reproduced, so that the user can reproduce contents recorded in succession only by performing an operation to admit continuation of the reproduction, and when reproduction of the contents recorded in succession is not required, the user is not required to perform the specific operation for admitting continuation of the reproduction, and therefore at a point of time when one unit of recorded contents is reproduced up to the end thereof, also reproduction can easily be stopped.

Further reproduction of reserved and recorded contents is performed at first in the reverse direction, and after reproduction of the contents with the possibility of extension of broadcast time thereof in the reverse direction is finished, recording of other contents provided through the same broadcasting service and recorded substantially in succession just before the contents reproduced in the reverse direction is searched out, and the other contents searched out as described above is reproduced in succession in the reverse direction, and with this functional configuration, even when fast-forward reproduction in the reverse direction is performed, contents actually recorded can continuously be reproduced in the reverse direction over the two successively recorded contents, and therefore also when a section to be reproduced is searched, for example, by the fast-forward reproduction in the reverse direction, a user is not required to be aware of a difference between units of recorded contents.

### BRIEF DESCRIPTION OF THE DRAWINGS

FIG. 1 is an explanatory view showing an example of system configuration according to an embodiment of the present invention;

FIG. 2 is a block diagram showing an example of configuration of a hard disk-based recording/reproduction apparatus according to an embodiment of the present invention;

FIGS. 3A and 3B are explanatory views showing an example of display according to an embodiment of the present invention;

FIG. 4 is a flow chart showing an example of processing for reservation of picture recording according to an embodiment of the present invention;

FIG. 5 is a flow chart showing an example of processing for schedule registration according to an embodiment of the present invention;

FIGS. 6A to 6E are explanatory views showing an example of program by program picture recording according to an embodiment of the present invention;

FIG. 7 is a flow chart showing an example (Example 1) of processing for reproduction according to an embodiment of the present invention;

FIG. 8 is a flow chart showing an example (Example 2) of processing for reproduction according to an embodiment of the present invention;

FIG. 9 is an explanatory view showing an example of display according to an embodiment of the present invention; and

FIGS. 10A to 10E are explanatory views showing a modified example of program by program picture recording according to an embodiment of the present invention.

### DETAILED DESCRIPTION

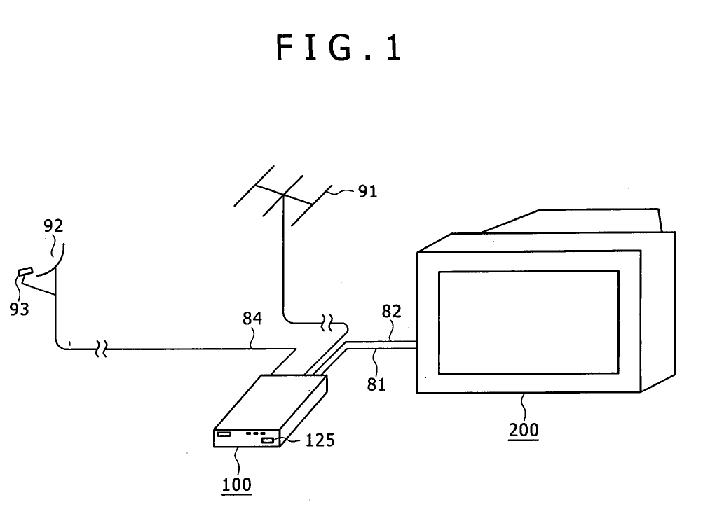

An embodiment of the present invention is described below with reference to the attached drawings. FIG. 1 is a view showing an example of system configuration according to the embodiment. In this example, a hard disk-based recording/reproduction apparatus 100 for recording pictures provided through television broadcasting services and a television receiver 200 are connected to each other. The hard disk-based recording/reproduction apparatus 100 is a video recording/reproduction apparatus incorporating therein a hard disk used for recording television broadcast programs and reproducing the recorded programs, and this hard disk-based recording/reproduction apparatus 100 incorporates a tuner for receiving surface waves for television broadcasting and a tuner for BS broadcasting signals (satellite broadcasting signals) each as a tuner for receiving signals for broadcasting services, and for example, an antenna 91 for surface waves and an parabola antenna 92 for broadcast waves from satellites are connected to the hard disk-based recording/reproduction apparatus 100. A converter 93 is attached to the parabola antenna 92, and satellite broadcast waves converted by the converter 93 are supplied thereto. Any unit such as a monitor receiver may be used as the television receiver 200 so long as the unit can receive video signals and audio signals from the hard disk-based recording/reproduction apparatus 100, display the images, and output the voices and sounds. The audio signals may also be supplied to an audio output device separated from the display device, and may be outputted from the audio output device.

The video signals and audio signals outputted from the hard disk-based recording/reproduction apparatus 100 are supplied via cables 81, 82 to the television receiver 200. The television receiver 200 can display pictures and output voices and sounds recorded in the hard disk incorporated in the hard disk-based recording/reproduction apparatus 100. Further, it is possible to connect a video signal source such as an independent tuner device to the hard disk-based recording/reproduction apparatus 100 for recording video signals and audio signals supplied from the video signal source in the hard disk.

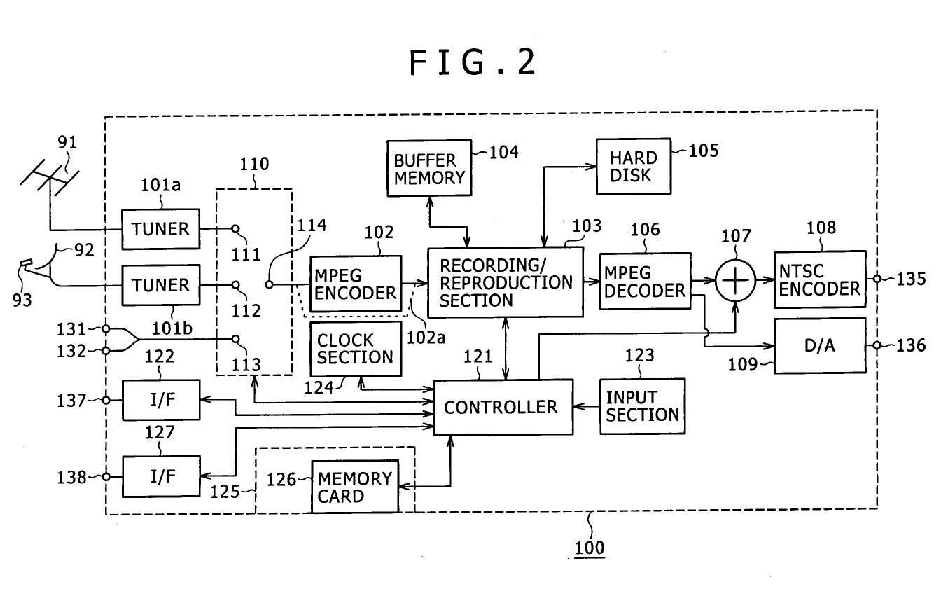

Configuration of the hard disk-based recording/reproduction apparatus 100 is described with reference to FIG. 2. The antenna 91 for surface waves connected to the hard disk-based recording/reproduction apparatus 100 is connected to a tuner 101a for surface waves incorporated in the apparatus 100, and supplies the video signals and audio signals for television broadcasting based on surface waves received with the tuner 101a to a terminal 111 of a switch 110. The converter 93 attached to the parabola antenna 92 connected to the hard disk-based recording/reproduction apparatus 100 is connected to a tuner 101b for satellite broadcasting incorporated in the apparatus 100, and supplies the video signals and audio signals for television broadcast based on satellite broadcast waves received by the tuner 101b to the terminal 112 of the switch 110.

The receiving channels with the tuners 101a, 101b are controlled by a controller 121 of the hard disk-based recording/reproduction apparatus 100. The surface waves received by the tuner 101a are analog broadcast waves, and for prespecified channels, EPG data for displaying an electronic program table is transmitted, for example, superimposing the data in blanking periods of the video signals several times a day at prespecified time points. The satellite broadcast waves received by the tuner 101b are digital broadcast waves, and the EPG data for displaying an electronic program table is multiplexed on broadcast data and transmitted from time to time.

The EPG data provides guidance not only for the channel on which the EPG data is superimposed, but also for almost all the programs provided through channels based on surface waves from broadcast stations and satellite broadcast waves and receivable within an area. Therefore, the tuner 101a functions as a program data acquisition unit for receiving channel data with the EPG data superimposed thereon (or added thereto) at a time point when the superimposition is performed and extracting the superimposed EPG data, while the tuner 101b functions as program data acquisition means capable of receiving and extracting the EPG data at any time. The EPG data received by the tuners 111a and 101b is transmitted to the controller 121. The controller 121 in this example has a function as processing means for extracting only necessary program data from supplied EPG data.

The switch 110 is used for switching among signals received by the tuner 101a, signals received by the tuner 101b, and those incoming to input terminals 131, 132 from outside. The input terminals 131, 132 are input terminals for video signals and audio signals used as a pair, and the signals incoming into the input terminals are supplied to a terminal 113 of the switch 110. Of the video signals and audio signals obtained at the terminals 111, 112, and 113, those selected according to control by the controller 121 are obtained at a terminal 114. In FIG. 2, when supplying and switching between video signals and audio signals are executed simultaneously, a transfer path for the two types of signals is shown with one transmission line.

The video signals or audio signals (signals obtained at the terminal 114) selected by the switch 110 are supplied to an MPEG (Moving Picture Experts Group) encoder 102, and is converted to digital video data and digital audio data each compressed and encoded according to, for example, the MPEG2 system. When the signals supplied to the encoder 102 are analog signals, also digital conversion for converting the analog signals to digital data is performed in the encoder 102 (or in an independent circuit). When the tuners 101a, 101b are those for receiving digital broadcast services and data already encoded according to the MPEG system is received, as indicated by a broken line in FIG. 2, the signals are transmitted to a circuit in the downstream via a path 102a not passing through the MPEG encoder 102. Also when video data and audio data based on the MPEG system are received, if conversion such parameters as a coding ratio is required, both decoding and encoding may be performed.

The video data and audio data based on the MPEG2 system acquired by the MPEG encoder 102 are supplied to a recording/reproduction section 103. The recording/reproduction section 103 is a circuit for recording video data, audio data and the like in a hard disk 105 and reproducing the recorded data. A buffer memory 104 is connected to the recording/reproduction section 103, and data is temporally stored in this buffer memory 104 for recording or reproducing. The hard disk 105 is also used as storage means (recording means) for electronic program data. Namely, the electronic program data processed by a controller 121 is recorded in the hard disk 105 or reproduced from the hard disk 105 under control by the controller 121. For storing the electronic program data, a memory (not shown) connected to the controller 121 may be used as storage means in place of the hard disk 105. The hard disk 105 is rotated by a spindle motor at a high speed and data is recorded therein or reproduced therefrom by a head, and has the recording capacity of, for example, several tens of G bytes, so that the television broadcast signals broadcasted for several tens of hours can be stored in the hard disk 105.

The video data and audio data reproduced from the hard disk 105 and processed by the recording/reproduction section 103 are supplied to an MPEG decoder 106 and are decoded from the format based on the MPEG2 system. The decoded video data is supplied via a mixer 107 to an NTSC encoder 108 and supplied as an analog video signal based on the NTSC system to an output terminal 135. The decoded audio data is converted to an analog audio signal by a digital/analog converter 109 and the analog audio signal is supplied to an output terminal 136. The output terminals 135, 136 correspond to the terminals connected to the television receiver with cables 81, 82 in FIG. 1.

In the descriptions above, a case is assumed in which video data and audio data received and demodulated by the tuners 101a, 101b are supplied to the MPEG encoder 102 and modulated to signals based on the MPEG system therein, but when the tuners 101a, 101b are those for receiving digital broadcast services and received broadcast data is those already modulated to the MPEG system or the like, the received data may be sent through a path 102a not passing through the MPEG encoder 102 without being modulated by the MPEG encoder 102 and recoded as they are in a recording medium (hard disk 105) as described above.

An instruction for operating the hard disk-based recording/reproduction apparatus 100 is supplied from an input section 123 including operation keys, a remote control signal receiving section (a light receiving section) and the like. For example, when an operating instruction is sent as an infrared-ray signal from a remote controller not shown to the input section 123, the received instruction is sent to a controller 121. Instructions sent from the remote controller or generated by operating the keys include, in addition to those for directly instructing recording, reproduction, and channel switching, multi-functional instructions for the so-called GUI (Graphical User Interface) operations generated by operating the cursor key, select key, and the like referring to a display on a receiver 300 connected to the hard disk-based recording/reproduction apparatus 100.

When the processing for generating a screen for the GUI operations is executed, the controller 121 sends data for the generated screen to the mixer 107 to mix the data with video data outputted from the MPEG decoder 106, so that a video signal outputted from the output terminal 135 is used as a video signal for displaying the corresponding screen.

In the hard disk-based recording/reproduction apparatus 100, also when various types of displays are required to be provided on any screen other than that for the GUI operations, the controller 121 generates data for the display screen and sends the data to the mixer 107. Examples of screens displayed in response to the processing as described above are described hereinafter.

A clock section 124 is connected to the controller 121, and the controller 121 checks from time to time the current time (year, month, day, hour, minute, and second) counted by the clock section 124. The controller 121 checks the current date and time counted by the clock section 124 and executes such operations as reserved picture recording. The time counted by the clock section 124 may be set or adjusted in response to an operation by a user, or may automatically be adjusted based on a signal received by the tuner 101a or 101b.

Further, the hard disk-based recording/reproduction apparatus 100 in this example has a card slot 125 in which a memory card can dismountably be set, and the controller 121 can read out data stored in a memory card 126 set in the card slot 125 for executing various types of operations. When still image data or moving picture data is stored in the memory card 126 set therein, the controller 121 reads out the image data and sends the data to the mixer 107 so that the data is displayed on the receiver 300 connected to the hard disk-based recording/reproduction apparatus 100. Also the data read out from the memory card 126 may be recorded, for example, in the hard disk 105.

Further, the hard disk-based recording/reproduction apparatus 100 in this example has a port 138 for connection to the Internet, so that the controller 121 can execute data transaction via communication means connected to the port 138 for connection to the Internet through an interface 127.

The port 138 for connection to the Internet can be connected, for example, to a router or a modem for connection to the Internet through a prespecified cable. Further, the controller 121 can acquire electronic program data by accessing a server at a prespecified address via the port 138 for connection to the Internet.

When the electronic program data is acquired by various types of operations, the controller 121 stores the electronic program data in a part of region of the hard disk 105 to use the processing for displaying the electronic program table or the processing for reservation of picture recording by utilizing the stored data. There are three types of electronic program data which can be acquired by the controller 121, namely electronic program data received by the tuner 101 incorporated therein, electronic program data obtained from the tuner device 200 connected thereto via the port 137, and electronic program data acquired via the Internet, and which of these three types of electronic program data is to be used is previously specified.

A non-volatile memory (not shown) is connected to the controller 121 so that various types of setting matters can be stored therein. Also the information concerning reservation of picture recording is stored in this non-volatile memory. Alternatively, a portion of a storage area of the hard disk 105 may be used in place of a non-volatile memory.

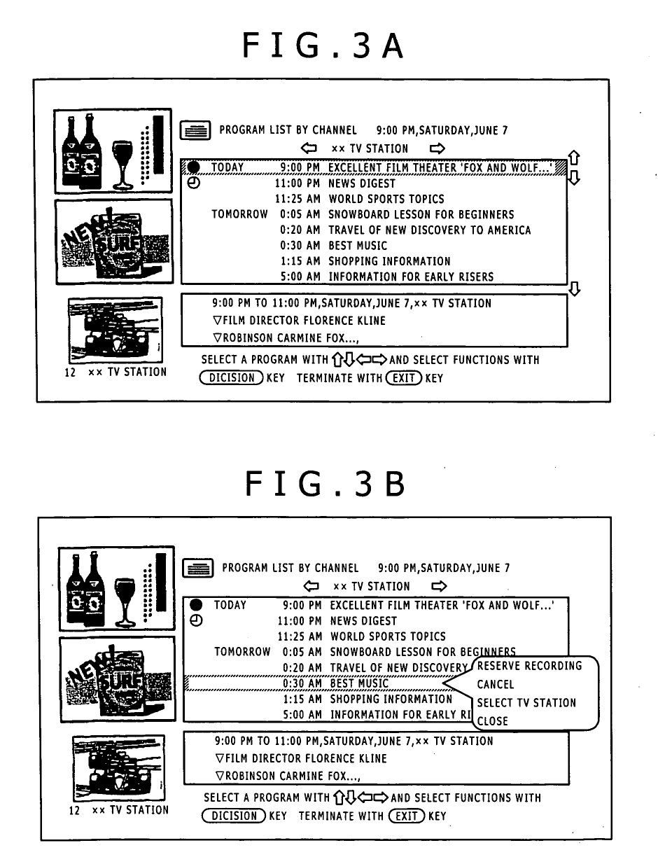

Descriptions are provided below for the processing executed for reservation for picture recording of a broadcast program or broadcast programs with the hard disk-based recording/reproduction apparatus 100 having the configuration as described above. In the hard disk-based recording/reproduction apparatus 100 in this example, when the EPG data is acquired and an electronic program table is prepared, an image of the electronic program table as shown, for example, in FIG. 3A, is displayed on the television receiver 200. Namely, in FIG. 3A, a date and time are displayed in the right upper portion of the screen, and also programs provided through an arbitrary broadcast station (channel) at the time point and on are displayed there.

A given commercial message and an image based on a signal received through the channel currently selected are displayed on the left side of the screen. Further, in the lower section of the screen, a comment on the program selected with the cursor and guidance for operations with, for example, a remote controller (not shown) are displayed. The comment on the program is a portion of the EPG data.

Namely, by operating any of cursor keys for upward, downward, leftward, and rightward movements provided on a remote controller not shown, a user can select a broadcast station (channel) indicated by rightward and leftward arrow marks displayed on this screen and a program indicated by upward and downward arrow marks also on the screen. Then a desired program is selected by operating the Select key.

When a desired program is selected, the screen changes as shown in FIG. 3B.

In this FIG. 3B, control items of “Reservation for picture recording”, “Cancel”, “Select”, and “Close” are displayed each with a balloon form from a column for the desired program as described above. Then, a user can select any of the control items by operating the cursor key and Select key.

When “Reservation for picture recording” is selected, an image for setting a reservation for picture recording is displayed on the television receiver 200. The above descriptions assume a case where a user selects a program to be recorded by operating necessary keys, but also the configuration is allowable in which a program to be recorded is automatically selected from a program table and reserved for recording based on data concerning the user's viewing situation in the past.

In a case where there is a possibility that broadcast time of a program reserved for picture recording is extended or is shifted afterwards due to the extension of a former program, the reservation for picture recording is made in consideration of the extension of broadcasting time. Herein a case is assumed in which an outside broadcast program of baseball as one of the sports programs is extended, and such an extension is herein referred to as processing of “baseball extension”.

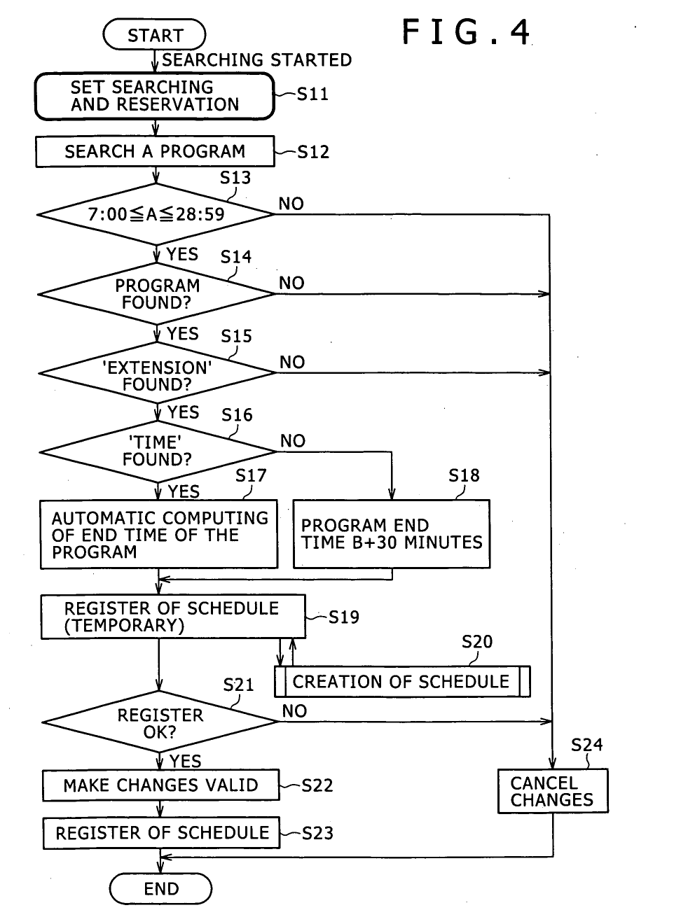

The flow chart in FIG. 4 shows an example of processing for reservation of picture recording when the broadcast time described above is extended. Descriptions are provided for the processing according to FIG. 4, and, upon the start of the processing, searching within the system is first conducted. Then processing of searching and setting a reservation is performed in step S11, and a program set for the processing of “baseball extension” is searched in step S12. Start time: A, end time: B, and broadcast station: Z are set in this step.

Next in step S13, whether the reservation subjected to the processing of “baseball extension” in relation to the start time: A or not is checked. Namely, a program whose reservation can be subjected to the processing of “baseball extension” is that having the start time: A of 7:00 AM to 28:59. 28:59 herein refers to the time 1 minute before 5:00 AM, when a program table of the day is switched to that of the following day.

Further, it is decided in step S14 whether or not there exists any program classified into “sports: baseball” in the programs broadcasted, for example, from 7:00 PM to 9:00 PM provided through the corresponding broadcast station: Z in an electronic program table. It is to be noted that whether a program matching a given condition exists or not is checked by a code of genre or subgenre of the program included in the EPG data.

Further, it is decided in step S15 whether or not a word “extension” is included in a character string constituting the electronic program table. When Yes is selected in any of steps S13 to S15, it is decided in step S16 whether or not a character constituting “hour, minute” is included in the character string constituting the electronic program table.

It is presumable that a character constituting “hour” is sometimes represented using a so-called external character, and in this case, the external character should be properly recognized for discrimination. A character constituting “hour, time” and time indicated by the character can be determined by the external character and the subsequent numeral character string.

When a character constituting “hour, time” is recognized in step S16 (Yes), automatic computing of the end time is performed in step S17. Namely, the maximum extended time Y is computed from the end time of a program whose comment represented with a character string constituting the electronic program table includes a word “extension”, and the determined time described above: D, as follows:
Y=D−C

The end time B′ of a program set for the processing of “baseball extension” after the actual extension is computed as follows:
B′=B+Y
When B′≧29:00, however, the end time B′ is computed as follows:
B′=29:00

When a character constituting “hour, time” is not recognized in step S16 (No), the end time B′ of the set program is computed as follows:
B′=B+30 minutes

A register of schedule according to the computed time is carried out in step S19. The register of schedule is, however, still temporary in this step. Further, the register of schedule is performed using a subroutine S20 separately provided for creating schedule, though descriptions thereof is omitted herein.

Then it is determined in step S21 whether recording according to the temporarily registered schedule can be performed or not. Namely, when a temporarily registered schedule is overlapped with other reservation(s), or recording according to the temporarily registered schedule causes capacity shortage, recording according to the temporarily registered schedule can not be executed.

Thus, in the determination in step S21, when recording according to the temporarily registered schedule in step S19 is possible (Yes), a change in schedule becomes valid in step S22. The changed schedule is finally registered in step S23 to terminate the processing.

In the determination in step S21, when recording according to the temporarily registered schedule in step S19 is not possible (No), a change in schedule is cancelled in step S24 to terminate the processing. It is to be noted that, when No is selected in any of steps S13 to S15, a change in schedule is also cancelled in step S14 to terminate the processing.

As described above, even when the broadcast time of a program prior to a desired program is extended, reservation for picture recording of the desired program is ensured eliminating the possibility that the last part of the desired program is not recorded.

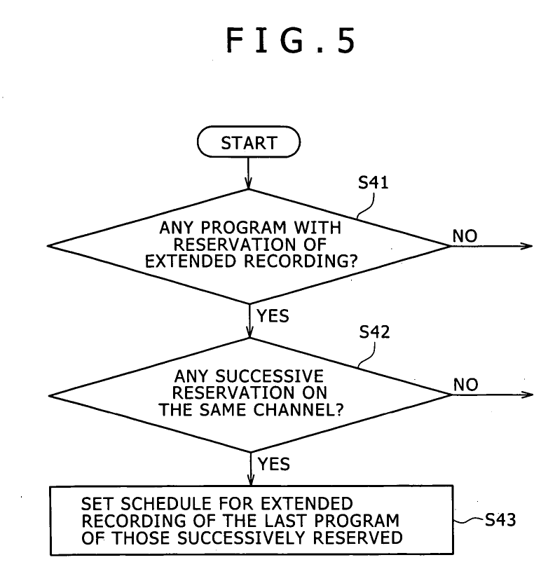

An example of processing for schedule registration of reservation for picture recording in a case where a plurality of reservation for picture recording are overlapped is as shown in, for example, a flow chart in FIG. 5. Namely, it is determined whether a program reserved for extension indicated by “baseball extension” as described above exists or not (step S41), and when there exists a program reserved for extension, it is determined whether there is a reservation for picture recording for other program in succession to the already reserved program on the same channel (step S42). When there is a reservation for picture recording for other program in succession to the already reserved program on the same channel, schedule is set in which the program lastly broadcasted among the programs reserved for picture recording in succession is to be recorded extending the recording time by a specified period of time (step S43). It is to be noted that, when the extended time can be determined from the EPG data or the like, the time to be extended for picture recording may be set separately.

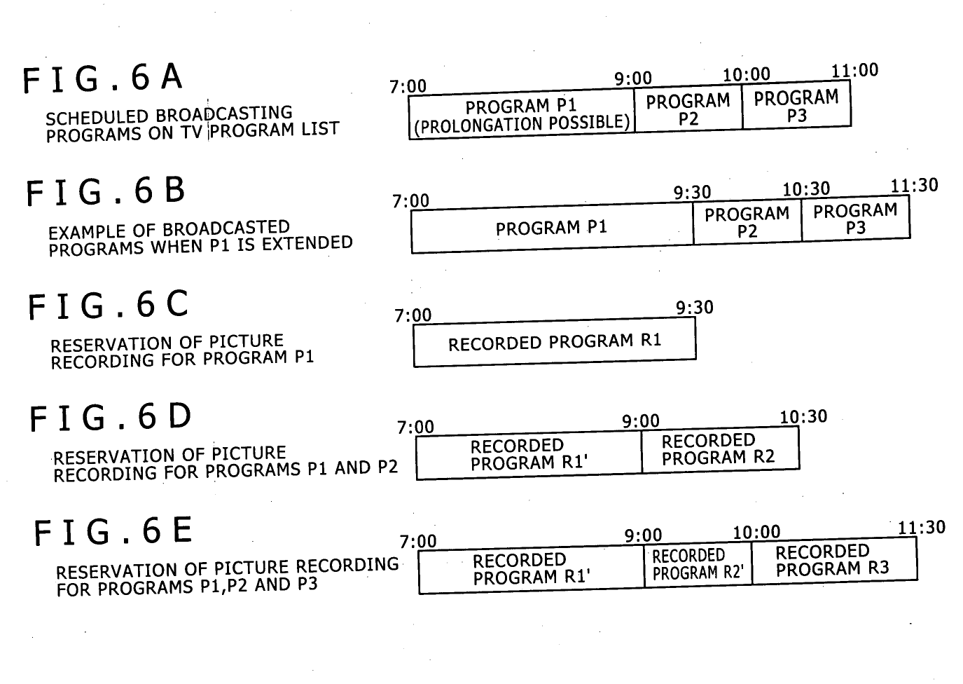

FIGS. 6A through 6E are a view showing an example of the state of picture recording for a program having the possibility of extension as described above. For example, a case is assumed in which a program table provides, as shown in FIG. 6A, a program P1 with the broadcast time 7:00 PM to 9:00 PM, a program P2 with the broadcast time 9:00 PM to 10:00 PM, and a program P3 with the broadcast time 10:00 PM to 11:00 PM as broadcasting schedule on a channel. Assuming herein that the controller 121 has determined that the program P1 is a sport outside program and may be extended by 30 minutes based on the EPG data.

FIG. 6B is a view showing an example of the actual state of broadcast programs when the program P1 is extended by 30 minutes. As shown in FIG. 6B, the broadcast time of the program P1 is extended by 30 minutes to be broadcasted from 7:00 PM to 9:30 PM, while the program P2 is broadcasted from 9:30 PM to 10:30 PM behind time by 30 minutes, and the program P3 is broadcasted from 10:30 PM to 11:30 PM behind time by 30 minutes.

Reservation for picture recording of a program possibly extended or behind schedule is made as follows. Firstly, when only the program P1 is reserved for picture recording, as shown in FIG. 6C, reservation for picture recording R1 with a time zone from 7:00 PM to 9:30 PM is made ensuring a complete recording, in case of extension of the program P1. When reservation for picture recording is made for the programs P1 and P2, as shown in FIG. 6D, reservation for picture recording R1′ with a time zone from 7:00 PM to 9:00 PM is made for the program P1, while reservation for picture recording R2 with a time zone from 9:00 PM to 10:30 PM is made for the program P2, which ensures a complete recording with the latter reservation. Further, when reservation for picture recording is made for the programs P1, P2 and P3, as shown in FIG. 6E, reservation for picture recording R1′ with a time zone from 7:00 PM to 9:00 PM is made for the program P1, reservation for picture recording R2′ with a time zone from 9:00 PM to 10:00 PM is made for the program P2, and reservation for picture recording R3 with a time zone from 10:00 PM to 11:30 PM is made for the program P3, which ensures a complete recording with the last reservation. It is to be noted that when reservation for picture recording is made only for two programs, namely program P2 and program P3, the reservation for picture recording is R2′ and R3 as shown in FIG. 6E.

As described above, the start time of reserved picture recording is set to that shown in the program table, and the recording time is extended within the possible range. Titles of programs P1, P2, P3 are assigned the programs R1 (R1′), R2 (R2′), and R3 reserved for picture recording and actually recorded, and the records are managed as independent recorded picture contents respectively. The records R1′ and R2 are data for extended programs not including the extended portions due to a failure in extended picture recording (namely data for extended programs not recorded up to the end thereof). In this example, the program not recorded up to the end due to a failure in extended recording is indicates as additional data to recorded picture contents. For example, such a message as “possibility of unsuccessful extended recording” may be added as program data. The data indicating a failure in extended picture recording may not be recorded.

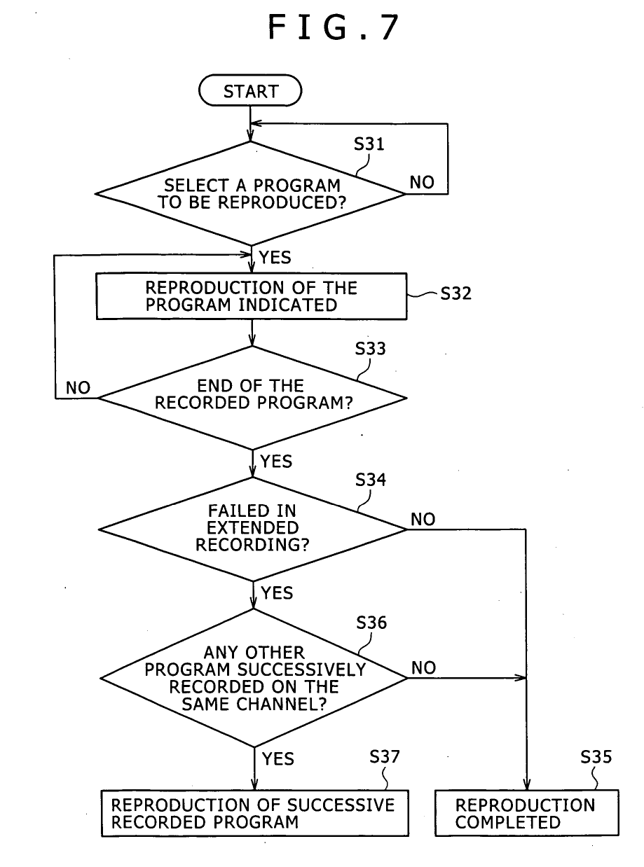

Next, descriptions are provided for the processing executed when a program recorded in the hard disk as described above is reproduced with reference to the flow chart in FIG. 7. When a recorded program is to be reproduced, for example, a user has a list of recorded programs displayed on the television receiver 200 connected to the hard disk-based recording/reproduction apparatus 100 and selects a program to be reproduced from the list. The controller 121 of the hard disk-based recording/reproduction apparatus 100 determines whether an operation for reproducing any recorded program has been made or not (step S31), and when it is determined that an operation for reproducing any recorded program has been made, the controller 121 reproduces the recorded contents having the specified program tile from a head thereof (step S32).

Then the controller 121 determines whether a reproduced position of the recorded contents having started to be reproduced comes to the end or not (step S33) and continues reproduction until the reproduced position comes to the end. It is needless to say that the user can carry out such operations as fast-forward, fast rewinding, and pause during the reproduction by performed necessary operations.

When it is determined in step S33 that the reproducing position has come to the end of the recorded contents, then the controller determines whether the program is an unsuccessful one in extended recording or not (step S34). Whether the program is an unsuccessful one in extended recording or not is determined, for example, by referring to data added to the recorded contents. When the program is not an unsuccessful one in extended recording, the controller 121 stops reproduction of the program (step S35).

When it is determined in step S34 that the program has the possibility of a failure in extended picture recording, the controller 121 determines whether contents for a program provided through the same broadcast channel in succession to the recorded contents reproduced just ahead has been recorded in the hard disk or not (step S36). The “program provided in succession” includes not only that provided continuously through the same channel, but also that provided with a relatively short interval such as several minutes.

When it is determined as a result of determination in step S36 that recorded contents for a program provided in succession (or in substantial succession) to the reproduced program through the same channel has been recorded in the hard disk, the controller reproduces the detected recorded contents in succession to the recorded contents reproduced in step S33 (step S37).

When the contents recorded in response to the picture recording reservation R2′ as shown, for example, in FIG. 6E is reproduced with the operations as described above, due to extension (delay) of broadcast time for the program P2, there is the possibility that a latter portion of the program P2 may not have been recorded, but by searching out contents corresponding to the picture recording reservation R3 for the program record in succession to the program above, the program P2 with the broadcast time extended can be reproduced up to the end thereof. Therefore, even when the recording time of recorded contents does not coincide with the actual broadcast time of the recorded program, the recorded contents for a program with the broadcast time extended can automatically be enjoyed without requiring the user to perform operations for searching out a program recorded in succession, which is advantageous.

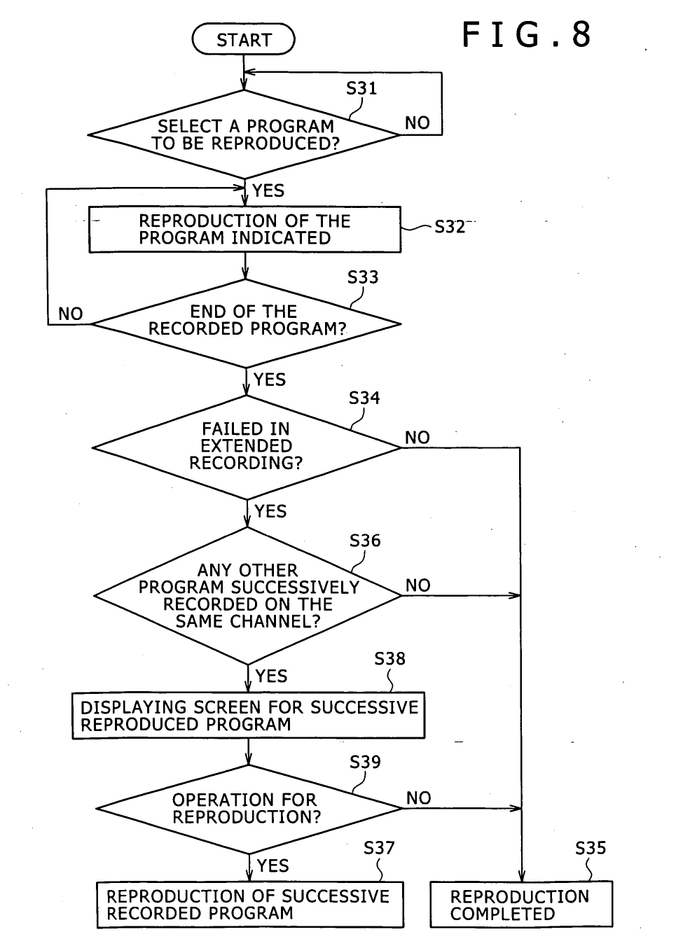

In the example shown by the flow chart in FIG. 7, when recorded contents recorded in succession is automatically reproduced, but also the configuration is allowable in which after the first recorded contents is reproduced up to the end, an inquiry as to whether the remaining portion of the contents is to be reproduced or not, and the remaining portion is reproduced only when the user admits reproduction of the remaining portion. The flow chart shown in FIG. 8 indicate the case described just ahead, and the processing sequence up to step S36 for determination as to whether the program provided in succession through the same channel has been recorded or not is the same as that in the flow chart shown in FIG. 7, and when the recorded contents for a program provided in succession through the same channel program is detected, the inquiry as to the need of reproduction of the remaining portion is displayed in the superimposed state on the reproduced picture (step S38).

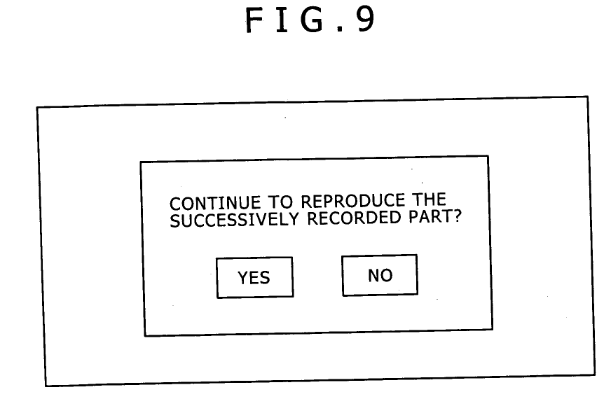

FIG. 9 shows an example of the screen for inquiring the necessity of reproduction of the remaining portion. In this example, the inquiry of “continue to reproduce the successively recorded part?” and displays of “YES” and “NO” are provided on the screen.

In the state where the displays as described above are provided on the screen, if a user selects successive reproduction, an operation for reproduction in succession to step S37 is started. For example, when “YES” is selected, for example, by operating a cursor key of the remote controller in the state shown in FIG. 9, the controller 121 of the hard disk-based recording/reproduction apparatus 100 determines that an operation for continuous reproduction has been made, and contents recorded in succession is reproduced. Other steps in the processing sequence are the same as those shown in the flow chart in FIG. 7.

By executing reproduction of contents recorded in succession inquiring the user of the necessity, when there is no extension nor delay of the broadcast time, reproduction can be finished at the end of the reproduced program, so that user can conveniently select the reproduction state visually checking the contents.

The processing sequences shown in the flow charts in FIG. 7 and FIG. 8 assume a case where recorded contents is reproduced in the regular direction and then the remaining portion is reproduced, but also when contents is reproduced in the reverse direction (so-called fast rewinding), if there is contents for a program provided through the same channel and recorded in succession just ahead, the contents provided through the same channel may continuously be reproduced. More specifically, when the contents recorded, for example, in response to the picture recording reservation R3 shown in FIG. 6E is reproduced in the reverse direction and the reproducing position comes to the head of the contents, the contents recording in response to the picture recording reservation R2′ may be reproduced in succession. Also in this case, as shown by the flow chart in FIG. 8, the necessity of successive reproduction may be inquired to the user. As described above, also in reproduction in the reverse direction, by reproducing the successive contents, a reproducing position can easily be returned, for example, to a head of a program.

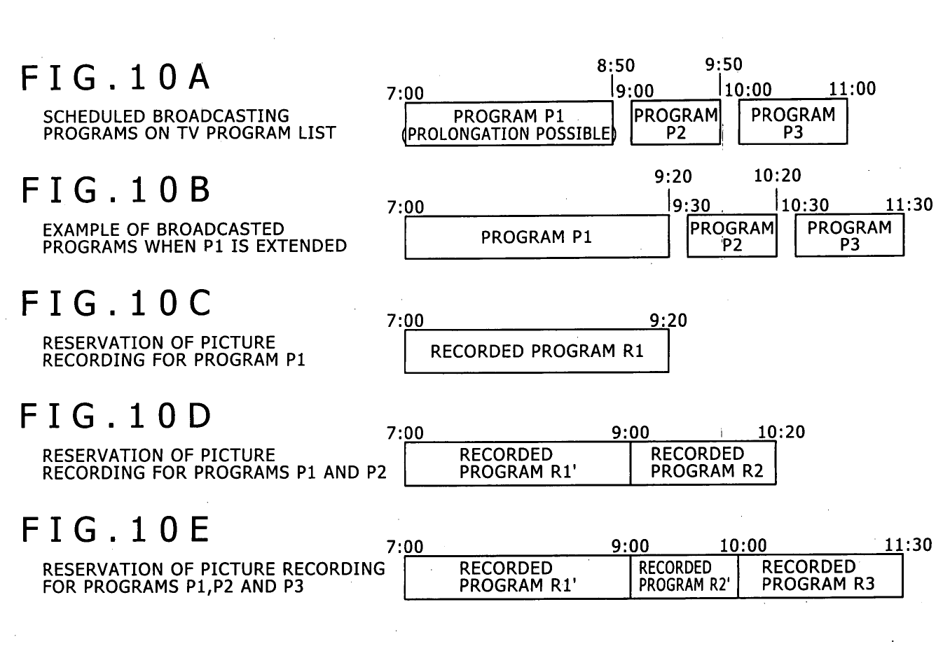

Further, in the processing for picture recording reservation shown in FIGS. 6A through 6E, reserved periods of time for recording a plurality of programs are successive because the programs are broadcasted in succession, but even in a case where the plurality of programs are to be broadcasted intermittently in the broadcast schedule shown in a program table, if reservation of picture recording for the plurality of programs is made in consideration of extension of broadcast time of any program and as a result the programs are recorded in succession, the same processing effect can be achieved. For example, in a program table showing a broadcast schedule of a channel shown in FIGS. 10A through 10E, there are a program P1 to be broadcasted from 7:00 PM until 8:50 PM, a program P2 to be broadcasted from 9:00 PM until 9:50 PM, and a program P3 to be broadcasted from 10:00 PM until 11:00 PM as shown in FIG. 10A. The program P1 is for relaying a sports game, and the possibility that the broadcast time may be extended by 30 minutes is shown in the program table based on the EPG data.

FIG. 10B shows an actual state of broadcast of the programs above when the broadcast time of the program P1 is extended by 30 minutes. AS shown in FIG. 10B, broadcast time of the program P1 is extended by 30 minutes and actually broadcasted from 7:00 PM until 9:20 PM, so that actual broadcast time of the program P2 is delayed by 30 minutes to 9:30 PM until 10:20 PM and that for the program P3 is delayed by 30 minutes to 10:30 PM until 11:30 PM.

Picture recording based on a reservation in this case is performed as described below. At first, when only the program P1 is reserved for picture recording, the reservation R1 for picture recording is made for the time zone from 7:00 pm until 9.20 pm as shown in FIG. 10C so that, even when the broadcast time for the program P1 is extended, the program can be recorded up to the end. When a reservation for picture recording is made for the program P1 and program P2, a time zone from 7:00 PM until 9:00 PM is reserved for recording the program P1 (picture recording reservation R1′) and a time zone from 9:00 PM until 10:30 PM is reserved for recording the program P2 (picture recording reservation R2′) as shown in FIG. 10D. In this case the program P1 can be recorded until the time point when the program P2 is started, and the recording time for the program P2 to be broadcasted in succession is extended. Further, when a reservation for picture recording is made for the program P1, program P2, and program P3, as shown in FIG. 10E, a time zone from 7:00 PM until 9:00 PM is reserved for the program P1 (picture recording reservation R1′), a time zone from 9:00 PM until 10:00 PM is reserved for the program P2 (picture recording reservation R2′), and a time zone from 10:00 PM until 11:30 PM is reserved for the program P3 (picture recording reservation R3). In this case the programs P1 and P2 are recorded in the extended times zones until the time point when the successive programs P2 and P3 are started respectively, so that also the program broadcasted last can be recorded in the extended time zone.

Also when the plurality of programs are recorded as shown in FIG. 10D or FIG. 10E, by providing controls for reproduction as shown in the flow chart in FIG. 7 or FIG. 8, each of the programs broadcasted intermittently can be reproduced up to the end.

Descriptions of the embodiment above assume a case where a hard disk is used as a recording medium, but the present invention can be applied also to a recording/reproduction apparatus using other types of recording (storage) media.

In the embodiments described above, tuners incorporated in the recording/reproduction apparatus are a tuner for receiving analog surface waves and a tuner for receiving BS broadcast waves, but for example, a tuner for receiving other types of broadcast services such as a tuner for receiving digital surface waves or a tuner for receiving CS broadcast waves may be used in this invention.

In the embodiment described above, a stand-alone television receiver is connected to the recording/reproduction apparatus, but the recording/reproduction apparatus having the functional configuration as described in this example may be incorporated in the television receiver.

Further, in place of the configuration described above in which a dedicated tuner or a recorder is provided like in the example described above, also the configuration is allowable in which a large capacity recording (storage) device corresponding to the recording/reproduction apparatus in this example and a board or a card for data transaction corresponding to the tuner in this example are provided in a personal computer for executing various types of processing and also in which software (a program) for providing controls over the processing for acquiring EPG data, recording broadcast data, and reproducing the recorded data for enabling the same processing for a reservation of picture recording as that described above is installed in the personal computer. If the software is capable of executing the same processes as those in the embodiment described above, a reservation for picture recording can be made in the similar way. The software may be distributed in the state where the software is stored in various types of recording media such as a CD-ROM or a DVD-ROM. Further, the software may be distributed through a transfer medium such as the Internet.

While a preferred embodiment of the present invention has been described using specific terms, such description is for illustrative purpose only, and it is to be understood that changes and variations may be made without departing from the spirit or scope of the following claims.

What is claimed is:

1. A recording/reproduction apparatus, comprising:
recording means for recording received contents data;
guidance information acquisition means for acquiring guidance information for said contents and storing the guidance information;
recording control means for reserving recording of contents with said recording means based on the guidance information stored in said guidance information acquisition means and extending a recording period of time for reservation within a time zone not conflicting with a reservation for recording other contents for contents with the possibility of extension of the broadcasting period of time indicated by said guidance information; and
reproduction control means for controlling reproduction of the contents recorded with said recording means, finding out, when reproduction of the contents with the possibility of extension of a broadcasting period of time for the same is terminated, other contents of the same broadcasting service recorded substantially in succession to the reproduced contents, and reproducing said other contents found out.

2. The recording/reproduction apparatus according to claim 1, wherein the reproduction control means displays, when reproduction of the contents with the possibility of extension of a broadcasting period of time for the same is terminated, an inquiry as to whether the reproduction is to be continued, and reproduces, when an instruction is given that the reproduction is to be continued, said other contents found out, based on said display.

3. The recording/reproduction apparatus according to claim 1, wherein the reproduction control means finds out, when reproduction of the contents with the possibility of extension of a broadcasting period of time for the same is terminated, recording of other contents for the same broadcasting service recorded substantially in succession to the reproduced contents, in a case where a extended picture recording of the reproduced contents turns out a failure, and reproduces said other contents found out.

4. The recording/reproduction apparatus according to claim 1, wherein the reproduction controlled by said reproduction control means is a backward reproduction, and the reproduction control means finds out, when reproduction of the contents with the possibility of extension of a broadcasting period of time for the same is terminated, recording of other contents for the same broadcasting service recorded substantially in succession to the reproduced contents, and continuously reproduces said other contents found out in the backward direction.

5. A method of recording/reproducing received contents, comprising:
acquiring guidance information for said contents;
reserving recording of contents with the possibility of extension of the broadcasting period of time, based on said acquired guidance information, by extending a recording period of time for reservation within a time zone not conflicting with a reservation for recording other contents; and
in reproducing said contents reserved for recording, finding out, when reproduction of the contents with the possibility of extension of a broadcasting period of time for the same is terminated, recording of other contents of the same broadcasting service recorded substantially in succession to the reproduced contents, and reproducing said other contents found out.

6. The method of recording/reproducing according to claim 5, further comprising:
in reproducing said other contents, displaying an inquiry as to whether the reproduction is to be continued, when reproduction of the contents with the possibility of extension of a broadcasting period of time for the same is terminated; and
reproducing, when an instruction is given that the reproduction is to be continued, said other contents found out.

7. The method of recording/reproducing according to claim 5, further comprising:
finding out, when reproduction of the contents with the possibility of extension of a broadcasting period of time for the same is terminated, recording of other contents for the same broadcasting service recorded substantially in succession to the reproduced contents, in a case where extended reproduction of the reproduced contents turns out a failure; and
reproducing said other contents found out.

8. The method of recording/reproducing according to claim 5, wherein the reproduction controlled by said reproduction control means is a backward reproduction, and the reproduction control means finds out, when reproduction of the contents with the possibility of extension of a broadcasting period of time for the same is terminated, recording of other contents for the same broadcasting service recorded substantially in succession to the reproduced contents, and continuously reproduces said other contents found out in the backward direction.

9. A system for recording broadcasted contents and reproducing the recorded contents, the system comprising:
a processor operable to execute instructions; and
instructions for performing a recording/reproducing method, the method including:
acquiring guidance information for said contents;
reserving recording of contents with the possibility of extension of the broadcasting period of time, based on said acquired guidance information, by extending a recording period of time for reservation within a time zone not conflicting with a reservation for recording other contents; and
finding out, when reproduction of the contents with the possibility of extension of a broadcasting period of time for the same is terminated, recording of other contents of the same broadcasting service recorded substantially in succession to the reproduced contents, and reproducing said other contents found out.

10. The system according to claim 9, wherein the method further includes:
in reproducing said other contents, displaying an inquiry as to whether the reproduction is to be continued, when reproduction of the contents with the possibility of extension of a broadcasting period of time for the same is terminated; and
when an instruction is given that the reproduction is to be continued, reproducing said other contents found out.

11. The system according to claim 9, wherein the method further includes:
finding out, when reproduction of the contents with the possibility of extension of a broadcasting period of time for the same is terminated, recording of other contents for the same broadcasting service recorded substantially in succession to the reproduced contents, in a case where extended picture recording of the reproduced contents turns out a failure; and
reproducing said other contents found out.

12. A medium having a program stored therein for providing controls for recording received contents and reproducing the recorded contents, said program comprising:
acquiring guidance information for said contents;
reserving recording of contents with the possibility of extension of the broadcasting period of time, based on said acquired guidance information, by extending a recording period of time for reservation within a time zone not conflicting with a reservation for recording other contents; and
finding out, when reproduction of the contents with the possibility of extension of a broadcasting period of time for the same is terminated, recording of other contents of the same broadcasting service recorded substantially in succession to the reproduced contents, and reproducing said other contents found out.

13. The medium according to claim 12, wherein the program further comprises:
in reproducing said other contents, displaying an inquiry as to whether the reproduction is to be continued, when reproduction of the contents with the possibility of extension of a broadcasting period of time for the same is terminated; and
when an instruction is given that the reproduction is to be continued, reproducing said other contents found out based on said display.

14. The medium according to claim 12, wherein the program further comprises:
when reproduction of the contents with the possibility of extension of a broadcasting period of time for the same is terminated, in a case where extended picture recording of the reproduced contents turns out a failure, recording of other contents for the same broadcasting service recorded substantially in succession to the reproduced contents found out; and
reproducing said other contents found out.
